(19) United States
(12) Patent Application Publication
(10) Pub. No.: US 2008/0230600 A1
(43) Pub. Date: Sep. 25, 2008

(54) METHOD, SYSTEM, AND APPARATUS FOR CONDUCTING A PURCHASE TRANSACTION

(76) Inventors: Cynthia Wills Black, Pittsburgh, PA (US); Hemant Baijal, Trumbull, CT (US)

Correspondence Address: BUCKLEY, MASCHOFF & TALWALKAR LLC, 50 LOCUST AVENUE, NEW CANAAN, CT, 06840, US

(21) Appl. No.: 11/687,796

(22) Filed: Mar. 19, 2007

(51) Int. Cl. G06K 5/00

(52) U.S. Cl. 235/380

(57) ABSTRACT

A system, method, and apparatus for conducting a purchase transaction include receiving account information from a payment card device for a purchase transaction, wherein an unrestricted funds account and a restricted funds account is associated with the payment card device; receiving account type data representative of one of the unrestricted funds account and the restricted funds account to associate with the purchase transaction by a transaction terminal; transmitting payment transaction data, including the account type data, from the transaction terminal to a payment network; routing the payment transaction data to one of a first network and a second network based on the account type data associated with the payment transaction data; determining whether the routing is successful; and re-routing, in an instance the routing is not successful, the payment transaction to the first network or the second network not selected in the routing of the payment transaction.

### BACKGROUND

Embodiments disclosed herein relate to payment systems. In particular, some embodiments relate to methods, apparatus, systems, and computer program products for performing a purchase transaction by a payment card device.

A number of programs have been established by states and/or the federal government to provide benefits to individuals. Each particular benefits program usually defines the type and amount of benefits provided and those deemed eligible to receive the benefits under the program. Historically, benefit recipients (i.e., beneficiaries) typically received their designated benefits in a paper format such as, for example, a check or a voucher. However, in an effort to leverage advantages that may be provided by electronic communication systems, some benefits have been distributed using Electronic Benefits Transfer (EBT). In general terms, the EBT system includes electronically disbursing government benefits through an EBT card. In some embodiments, the EBT card may include a magnetic stripe or a smart card that may be accepted by a merchant for purchases. EBT has, in many instances, alleviated the need to distribute benefits in the form of checks and/or vouchers.

An advantage provided by some embodiments of EBT is the convenience provided a beneficiary by being able to make purchases using the EBT card instead of a paper voucher and/or having to cash a paper benefits check. However, an EBT card may be associated with a limited number or types of government benefits and may be further limited to a restricted number or type of purchase transactions.

### BRIEF DESCRIPTION OF THE DRAWINGS

Features and advantages of some embodiments of the present disclosure, and the manner in which the same are accomplished, will become more readily apparent upon consideration of the following detail description of the invention taken in conjunction with the accompanying drawings, which illustrate preferred and exemplary embodiments and which are not necessarily drawn to scale, wherein:

FIG. 1 is an exemplary diagram illustrating a front side view of payment device, according to some embodiments herein;

FIG. 2 is an exemplary diagram illustrating a rear side view of payment device, according to some embodiments herein;

FIG. 3 is an exemplary flow diagram, according to some embodiments of herein;

FIG. 4 is another exemplary flow diagram, according to some embodiments of herein;

FIG. 5 is an exemplary flow diagram, in accordance with some embodiments herein; and

FIG. 6 is an exemplary diagram illustrating a system, according to some embodiments herein.

### DETAILED DESCRIPTION

Applicant has recognized that there is a need for methods, systems, apparatus, means and computer program products for disbursing and processing a combination of EBT programs having restricted funds and other benefit programs having unrestricted funds via a single payment card.

In some embodiments, a payment card associated with a restricted funds account and an unrestricted funds account is provided that allows a beneficiary of a benefits program disbursing restricted use funds and a benefits program disbursing unrestricted funds to initiate purchase transactions with the payment card. The unrestricted funds account and the restricted funds account are each associated with their appropriate banking payment processing network. The result is a method, apparatus, and system that enables both restricted use and unrestricted use benefits disbursement and access via a single payment card.

A number of terms will be used herein to describe features of some embodiments of the present disclosure. For example, as used herein, the term “payment card” is used to refer to a card or device that is issued by an issuer financial institution to a “cardholder” for use in making purchases of goods or services. A payment card may be a credit card, a debit card, a stored value card, or other card that is associated with a payment account and which allows the cardholder to access funds or credit to make a purchase of goods or services. A payment card may be issued pursuant to the rules of a card association such as Quest®, MasterCard®, Visa®, American Express®, Discover® and the like.

As used herein, the term “acquirer” refers to a financial institution or financial institution processor that has a relationship with a merchant to acquire payment card transaction information and obtain settlement for transactions with an account issuer.

As used herein, the term “issuer” refers to a financial institution or financial institution processor that issues payment card or other financial accounts to cardholders allowing the cardholders to access funds or credit in the account.

As used herein, the term “transaction terminal” refers to a device or system located at or in association with a merchant that allows customers to purchase goods or services using payment cards. A transaction terminal may be, for example, a point of sale (“POS”) device, a software system, or the like that allows a merchant to obtain payment card data from a payment card device and to associate the payment card data with transaction data to complete a purchase transaction.

As used herein, the term “payment card network” refers to a network operated by or on behalf of a payment card association or system. For example, one payment card network is the BankNet® network operated by MasterCard®. Another example payment card network is the VisaNet® network operated by Visa®. In general, embodiments may operate with any payment card network that facilitates interaction between acquirers and issuers to authorize, deny or settle payment card transactions.

As used herein, the term “approval code” is used to refer to an identifier or code that is created by the payment card network for a transaction that is authorized or approved.

In some embodiments as illustrated in FIG. 1, a front-side view of a payment card that may be provided to facilitate disbursement of both EBT restricted funds and unrestricted funds is shown, generally referenced by numeral 100. In some embodiments, the shape, size, and format of payment card 100 may conform to a national or international standard such as, for example, ISO 7810 that defines characteristics of credit cards. In some embodiments, payment card 100 may be in the form of a mini- or sub-card that is smaller than an ISO 7810 ID-1 form factor.

Payment card 100 may include a primary account number 105 on the face thereof. Primary account number 105 may correspond to a standardized format (e.g., 15 or 16 digit numbers) so that an industry standard transaction terminal may readily accept and process the card. Card 100 may also include the name of the cardholder 110 to whom the card was issued, as well as an expiration date 115 for the card. Cardholder name 110 and expiration date 115 may be used, alone or in combination, to provide a measure of security to card 100. For example, name 110, expiration date 115, and logo 130, including security features therein, may be used to identify and/or authenticate the cardholder and the card by a merchant.

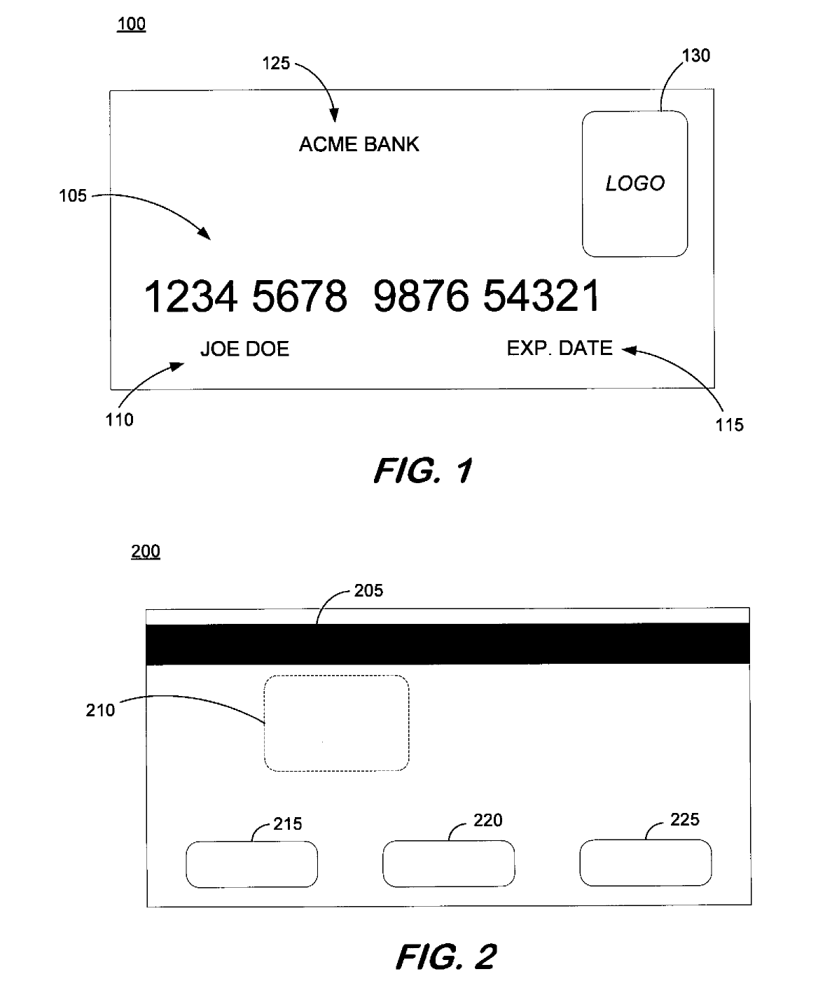

FIG. 2 is an exemplary rear-side view of a payment card 200, in accordance with some embodiments herein. Payment cards 100 and 200 may, though not necessarily, be opposite faces of the same payment card. In some embodiments, payment card 200 includes a magnetic stripe 205 containing identifying data, such as account number and cardholder name. The data contained on the magnetic stripe is communicated, alone or in combination with other transaction data, during a purchase transaction to effectuate a purchase using the payment card.

In some embodiments, payment card 200 may include a smart card. In such cases, a module 210 may be provided that includes an integrated circuit chip (e.g., a memory, a microprocessor). In some embodiments card 200 may be a contactless smart card wherein module 210 includes RFID components. Card 200 may include one or both of magnetic stripe 205 and module 210.

In some embodiments, marks 215, 220, and 225 may be included on card 200 to identify compatible payment processing networks for card 200. In some embodiments, one of the marks (e.g., 215) may be related to a restricted funds network and rules such as, for example, the QUEST® mark. One or more of the marks (e.g., 220, 225) may be representative of a payment processing network associated with unrestricted funds account(s) linked to payment card 200 such as, for example, BankNet® network operated by MasterCard International and other banking networks.

In this manner, given the association of payment card 200 with both (1) a restricted funds account and related processing network, and (2) an unrestricted funds account and related processing network network, payment cards disclosed in accordance with the teachings herein may be referred to co-branded cards. That is, the payment cards (e.g., 100, 200) are branded with the marks or identifiers to indicate the two or more banking networks (e.g., 215, 220, 225) associated with the restricted funds account and the unrestricted funds account.

It should be appreciated that the restricted funds account and the unrestricted funds accounts may each be associated with one or more accounts. For example, the restricted funds account may be associated with Food and Nutrition Services food stamp program benefits administered by the U.S. Department of Agriculture (FNS), Supplemental Food Program for Women, Infants, and Children (WIC) benefits, etc. that place restrictions on the particular types of purchase transactions for which the funds can be used. The unrestricted funds account may be associated with more than one type of benefits program that does not place any restrictions on the particular types of purchase transactions for which the funds can be used (child support, unemployment insurance, etc.).

In some embodiments, the unrestricted funds account and the restricted funds account herein may each be associated with or compatible with one or more payment processing or banking networks. In some embodiments, the network(s) associated with the restricted funds account is compatible with the rules and regulations governing the administration of benefits associated with restricted funds accounts. Similarly, the network(s) associated with the unrestricted funds (i.e., cash) account is compatible with the rules and regulations governing the administration of the benefits associated with the unrestricted funds (i.e., cash) accounts such that the unrestricted funds may be used for all types of purchase transactions.

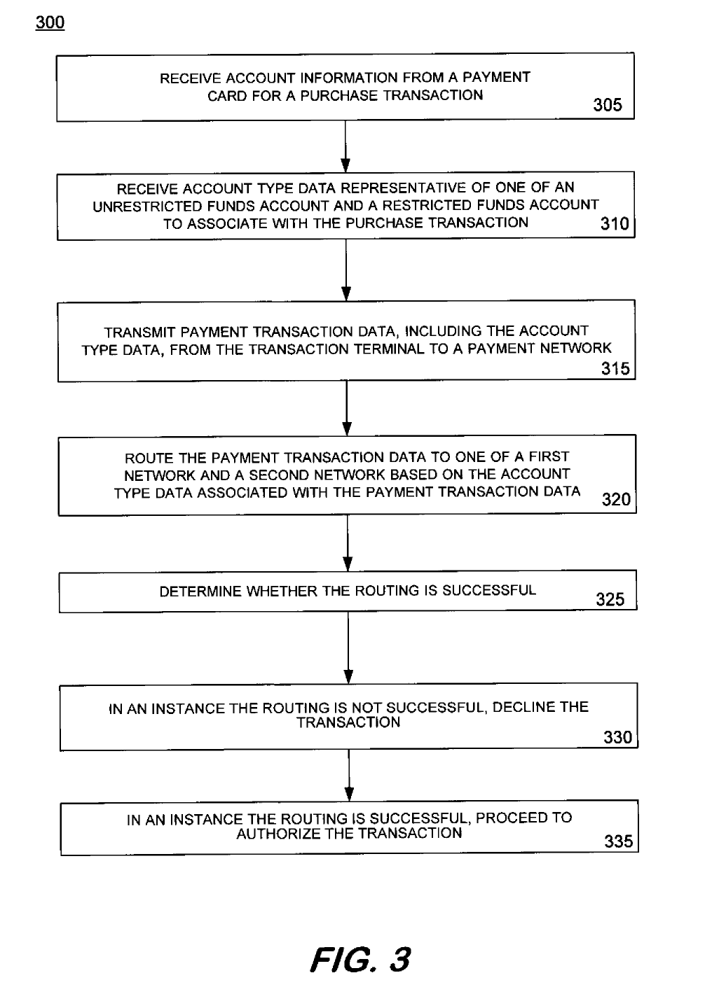

FIG. 3 is an exemplary flow diagram of a process 300 for conducting a purchase transaction, in accordance with some embodiments herein. At operation 305 account information is received from a payment card 100, 200 for the purchase transaction. The account information may include the primary account number 105 and the name of the cardholder. The account information may be received from the payment card by a merchant via a transaction terminal that reads the account information from magnetic stripe 205 and/or module 210. In some instances, the merchant may manually enter account information from payment card 100, 200 into the transaction terminal. In an instance a purchase transaction is made in the context of an on-line or similar environment where the merchant and cardholder are not physically co-located, the cardholder may transmit the account information to the merchant (e.g., via telephone or on-line shopping cart) manually or electronically.

At operation 310, an account data type representative of an unrestricted funds account or a restricted funds account is received and associated with the purchase transaction. The account data type may indicate whether the purchase transaction is to be completed using funds from an unrestricted funds account such as, for example, an unrestricted funds account analogous to cash or the purchase transaction is to be completed using funds from a restricted funds account such as, for example, funds associated with FNS and WIC benefits.

In the instance the account data type is representative of the unrestricted funds account, there are no limitations or prohibitions placed on the types of transaction purchases for which the unrestricted funds may be used. For example, the unrestricted funds account may be associated with benefits programs that distribute funds to qualified beneficiaries without limitations on how or for what the funds are used. Such benefits programs may include cash benefits such as, for example, uninsured benefits, child support payments, government pension payments, etc. Since there are no limitations or prohibitions placed on the types of transaction purchases for which the unrestricted funds may be used, purchase transactions using the unrestricted funds are also referred to herein as cash purchases.

In the instance the account data type received is representative of the restricted funds account, there are limitations or prohibitions placed on the types of transaction purchases for which the restricted funds may be used. For example, the restricted funds account may be associated with FNS benefits, WIC benefits, and other programs that distribute funds to qualified beneficiaries with specific limitations regarding the goods and services for which the funds may be used. Since there are in fact limitations or prohibitions placed on the types of transaction purchases for which the restricted funds may be used, purchase transactions using the unrestricted funds are also referred to herein as EBT purchases.

At operation 315, payment transaction data, including the account data type is transmitted to a third party processor (TPP or processor) and a payment processing network for authorization of the purchase transaction using the funds associated with the indicated account data type, either the restricted funds account or the unrestricted funds account.

In an instance the account data type transmitted indicates a purchase associated with the unrestricted funds account, the purchase transaction data may further include an indication of a type of security verification used for the transaction. For example, a PIN, a signature, or biometric data may be obtained from the cardholder making the purchase as a security mechanism to verify the identity of the cardholder. In some embodiments, a payment processing network (e.g., Maestro™) and/or a POS/merchant's liability may be based, at least in part, on the type of security verification obtained from the cardholder.

At operation 320, process 300 proceeds to route the payment transaction data to the appropriate payment processing network based on the account data type associated with the payment transaction data. The payment processing network may further be based on the security verification obtained from the cardholder. A processor or merchant acquirer (also known as an acquirer) may route the payment transaction data to either a first network or a second network based, at least, on the account type data associated with the payment transaction data.

The first and second network may each include a processing gateway (or an ISO acting for or on behalf of the gateway) associated with the type of transaction being processed. For example, in the instance unrestricted funds account is associated with the purchase transaction, a debit or credit processing gateway may be used, depending for instance on whether a cash withdrawal or a purchase of goods/services is being performed. In the instance restricted funds account is associated with the purchase transaction then an EBT gateway may be used.

At operation 325 a determination is made whether the routing of the transaction data of operation 320 was successful. For example, the determination is made whether a purchase transaction associated with the unrestricted funds account and intended to be routed to, associated with, or designated with processing of the unrestricted funds account is routed successfully. Likewise, operation 325 may also determine whether purchase transactions associated with the restricted funds account and intended to be routed to a payment processing network capable, associated with, or designated with processing the restricted funds account is routed successfully.

In an instance the routing of the transaction data to the proper network is not successful, process 300 proceeds to decline the transaction at operation 330. That is, the processing of the purchase transaction concludes. In some embodiments, the ending of the purchase transaction due to the unsuccessful routing of the transaction data (e.g., wrong network accessed or used given the account data type) includes sending an indication of the decline to the POS/merchant and/or cardholder by the processor or acquirer. Upon receipt of a declined purchase transaction, the POS/Merchant and/or cardholder may re-submit the purchase transaction or take other action(s) with the purchase transaction data in order to complete the purchase.

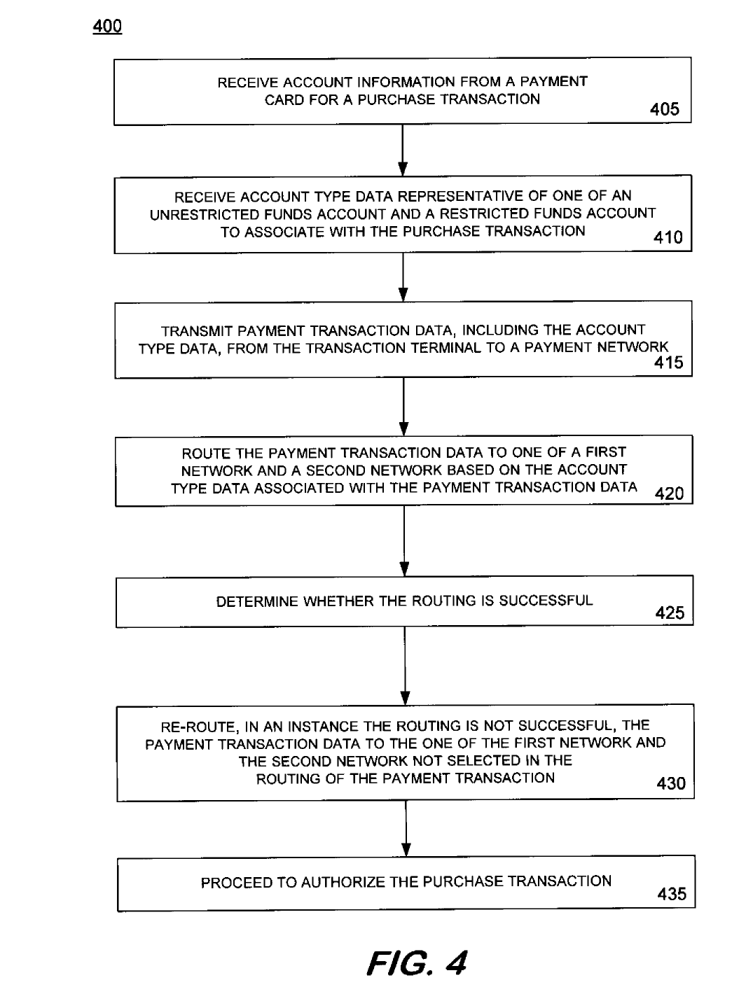

FIG. 4 is an exemplary flow diagram of a process 400 for conducting a purchase transaction, in accordance with some embodiments herein. Process flow 400 may is similar in some respects to the process depicted in FIG. 3. For example, operations 305-325 and operations 405-425 may be analogous operations. Thus, a detailed discussion of operations 405-425 is not provided since such insight may be had by referring to FIG. 3 and the discussion of same.

At operation 405, account information is received from a payment card 100, 200 for the purchase transaction, including the primary account number 106 and the name of the cardholder. At operation 410, an account data type representative of an unrestricted funds account or a restricted funds account is received and associated with the purchase transaction. The account data type may indicate whether the purchase transaction is to be completed using funds from an unrestricted funds account or a restricted funds account. In some embodiments, the format of the account number (i.e., number or length of account number string, sequencing of certain digits in account number, etc.) may convey the account data type.

At operation 415, payment transaction data, including the account data type, is transmitted to a processor and a payment processing network for authorization of the purchase transaction using the funds associated with the indicated account data type.

In an instance the account data type transmitted indicates a purchase associated with the unrestricted funds account, the purchase transaction data may further include an indication of a type of security verification used for the transaction. For example, a PIN or a signature may be obtained from the cardholder making the purchase as a security mechanism to verify the identity of the cardholder. In some embodiments, a payment processing network (e.g., Maestro™) and/or a POS/merchant's liability may be based, at least in part, on the type of security verification obtained from the cardholder.

At operation 420, the acquirer or processor routes the payment transaction data to the appropriate payment processing network based on the account data type associated with the payment transaction data. The payment processing network may further be based on the security verification obtained from the cardholder. The processor or acquirer may route the payment transaction data to either a first network or a second network based, at least in part, on the account type data associated with the payment transaction data. The first and second network may each include a processing gateway (or an ISO acting for or on behalf of the gateway) associated with the type of transaction being processed.

At operation 425 a determination is made whether the routing of the transaction data of operation 420 was successful. In an instance the routing is successful, the processing of the purchase transaction continues at operation 435 where an authorization process occurs to obtain an approval or rejection for the amount and goods/services associated with the purchase transaction.

In an instance the routing of operation 420 is not successful as determined at 425 (by the processor or acquirer), process 400 proceeds to operation 430 to re-route the transaction data to a payment processing network other than the network of the initial routing operation 420 for the authorization of the purchase transaction. For example, if the purchase transaction was routed to a network for processing an unrestricted funds account but the purchase transaction was actually associated with a restricted funds account, then the purchase transaction would be re-routed to a network associated with processing restricted funds account. Also, if the purchase transaction was routed to a network for processing a restricted funds account but the purchase transaction was actually associated with an unrestricted funds account, then the purchase transaction would be re-routed to a network associated with the processing unrestricted funds account.

In some embodiments, the re-routing includes re-formatting of at least part of the purchase transaction data.

In some embodiments, the account data type is identified, determined, or otherwise conveyed based, at least in part, on a format of the account information associated with the purchase transaction. In some of these embodiments, one or both of the routing process (420) and the re-routing process (430) may include re-formatting the account information to a format or configuration necessary to further route or re-route the payment transaction data.

In some embodiments, re-routing 430 is automatically performed when operation 425 determines the routing of operation is not successful. Accordingly, process 400 may proceed to operation 430 without further user approval or intervention to complete the routing of the transaction data to the appropriate payment processing network.

The processing of the purchase transaction may continue at operation 435 where an authorization process occurs to obtain an approval or rejection for the amount of the purchase transaction. In some embodiments, an approval code may be obtained for the transaction and communicated to the POS/merchant to authorize the purchase transaction. Further, the payment transaction data and the approval code may be used to settle the transaction between the payment cardholder's issuing bank and an acquiring bank associated with the POS/merchant so that the merchant's account is credited with the proper transaction amount.

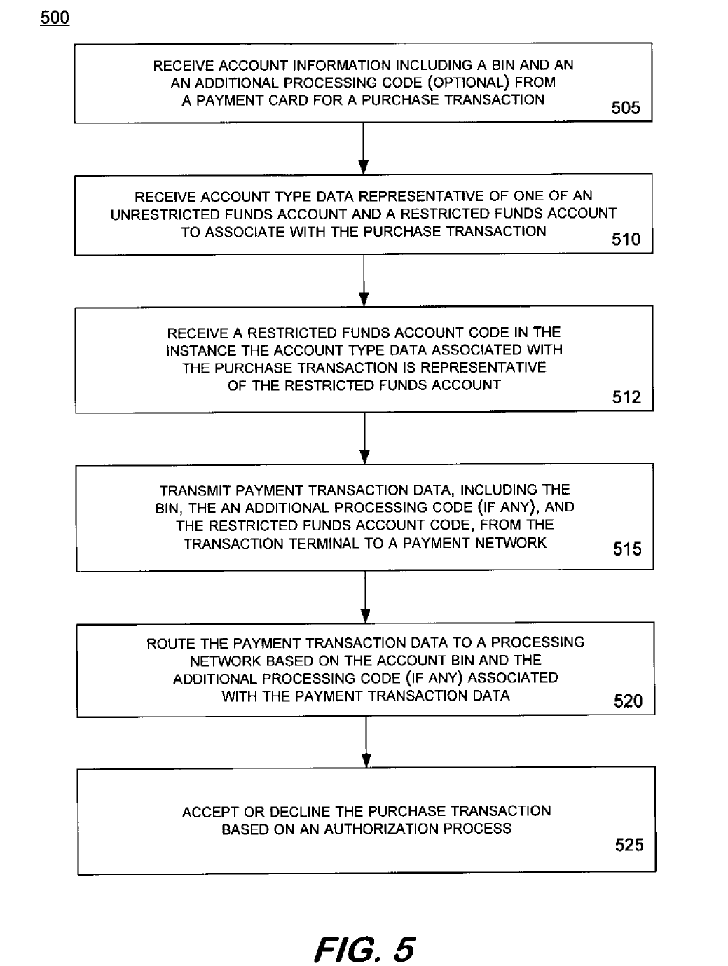

In some embodiments such as FIG. 5, a restricted funds associated purchase transaction (e.g., a FNS purchase) may be initiated by a cardholder submitting account information including a BIN (bank identification number) at operation 505. The BIN may indicate the institution that issued the card to the cardholder. The cardholder or the merchant/POS may further indicate that the purchase is to be associated with restricted funds account at operation 510. A processor may use the BIN to route the purchase transaction information to the appropriate processing network (e.g. Maestro) at operations 512, 515, and 520 and further onto a gateway (or ISO) for authorization at operation 525.

In some embodiments the restricted funds associated purchase transaction may be initiated by a cardholder submitting account information including the BIN and an additional processing code that identifies the purchase transaction as a restricted funds account associated transaction (505). A processor may use the BIN and the additional processing code to route the purchase transaction information to the appropriate EBT gateway (or ISO) (521, 515, and 520) and further for authorization (525). In some embodiments, the inclusion of the additional processing code may be at the option of the POS/merchant, processor, or issuing bank/institution.

In some embodiments, the format of the account information (e.g., BIN) or the cardholder may indicate the purchase transaction is to be funded by a restricted funds account by, for example, selecting an “EBT” designation at a POS terminal. Selection of “EBT” at the purchase terminal may further require a personal identification number (PIN) to continue the purchase transaction at operation 512.

In some embodiments, the presence of the restricted funds account code or a data element representation thereof in the transaction payment data (e.g. account number format) may be used by an unrestricted funds account processor, acquirer, or processing network as an indication that the transaction data is to be processed instead by a restricted funds account processing network. Conversely, the absence of the restricted funds account code or data element representation thereof in the transaction payment data may be used by an unrestricted funds account processing network as a confirmation that the payment transaction data is to be processed by the unrestricted funds account processing network

In some embodiments, the re-routing of the transaction data from the unrestricted funds account payment processing network to the restricted funds account payment processing network includes providing a “switch fee” the unrestricted funds payment processing network for switching the processing of the transaction data to the restricted funds account payment processing network.

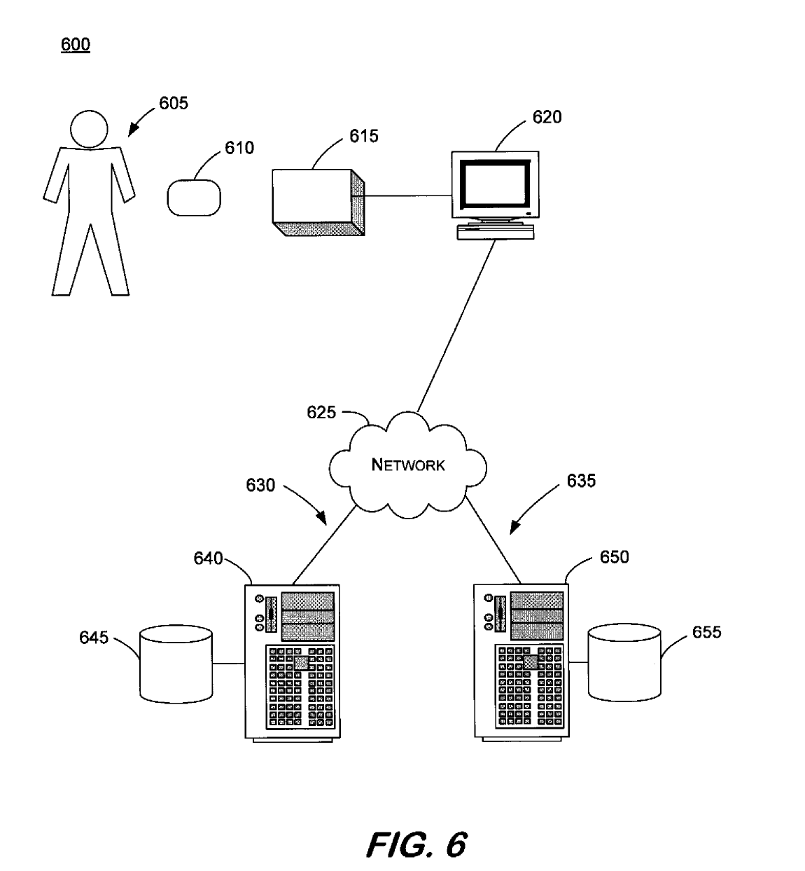

FIG. 6 is an exemplary diagram illustrating various aspects of a system 600, in accordance herewith. FIG. 6 shows a card 610 that is issued to cardholder 605. Cardholder 605 presents payment card 610 to a merchant (not shown) for payment for a purchase transaction of goods and/or services. Payment card 610 may be swiped a POS terminal 615 to retrieve account information from payment card 610. Cardholder 605 may provide an indication of an account data type representative of an unrestricted funds account or a restricted funds account to associate with the purchase transaction. The account data type may be selected at POS terminal 615. The account data type and other payment transaction data may be communicated to a network via a terminal 620 (e.g., a cash register, merchant order processing system such as an electronic shopping cart or processor) in communication with network 625.

In the instance the account data type is representative of the unrestricted funds account, there are no limitations or prohibitions placed on the types of transaction purchases for which the unrestricted funds may be used. In the instance the account data type received is representative of the restricted funds account, there are limitations or prohibitions placed on the types of transaction purchases for which the restricted funds may be used. The payment transaction data, including the account data type is transmitted to a payment network for authorization of the purchase transaction using the funds associated with the indicated account data type, either the restricted funds account or the unrestricted funds account.

The payment transaction data is routed to the appropriate payment processing network (e.g., network 630, including server 640 and data store 645) based on the account data type associated with the payment transaction data. Payment processing networks 630 and 635 each process one of a restricted funds account or an unrestricted funds account. In an instance the routing of the payment transaction data is successful, the purchase transaction is authorized and subsequently settled.

In an instance the routing of payment transaction data not successful, the payment transaction data may be denied or re-routed to an alternative payment processing network other than the network of the initial routing operation (e.g., network 635, including server 650 and data store 655) for the authorization, clearing, and settlement of the purchase transaction.

It should be appreciated that networks 630 and 635, servers 640 and 650, and data stores 645 and 650 are illustrative of the various systems functions attributed thereto in the present disclosure. Accordingly, the networks, severs, and memories referenced herein are not limited to the specific depictions shown in the various drawings of the present disclosure. For example, while each of payment processing networks 630 and 635 may be associated with one of the restricted funds account or the unrestricted funds account, more than one banking, payment, or processing network may be associated with payment processing network 630 and/or payment processing network 635.

Furthermore, the communication connections and links between the various components of system 600 may be established on a less than full-time basis. For instance, communication between the various system components may be made on an as-needed basis.

In some embodiments, communication between the system components made be made via a wireless communications links, not limited to a particular protocol and/or frequency.

In some embodiments, a payment card (e.g., 100, 200) in accordance with the disclosure herein may be used by a cardholder to effectuate a cash disbursement. In a first instance, a cardholder may use the payment card to withdraw cash from an automated teller machine (ATM). The processing of the ATM withdrawal request may be accomplished by forwarding ATM withdrawal transaction data (e.g., amount, ATM location, PIN submitted, etc.) to an ATM network associated with the ATM location used by the cardholder. The ATM withdrawal transaction data may further be transferred to a computer network (e.g., Cirrus™) associated with the payment card from the ATM network. The computer network may then forward the ATM withdrawal transaction data to an EFT (electronic fund transfer) gateway (or ISO operating in the capacity of the gateway) to obtain authorization data for the requested ATM withdrawal from an authorization database. The authorization data, including an indication of whether the ATM withdrawal request is declined or accepted, is returned to the gateway and then the computer and ATM networks to either approve or decline the ATM withdrawal request at the ATM. If approved, the cardholder is provided the requested ATM withdrawal amount of cash at the ATM. It should be appreciated that one or more fees may be charged to the cardholder or another entity for the processing of the ATM withdrawal.

In a second instance, a cardholder may use the payment card to request a cash disbursement at a POS. The processing of the POS cash disbursement request may be accomplished by forwarding POS cash disbursement transaction data (e.g., amount, POS/merchant I.D., form of verification (e.g., PIN or signature), etc.) from the POS to a computer network (e.g., Maestro™) associated with the payment card. The computer network may then forward the POS cash disbursement transaction data to an EFT gateway (or ISO operating in the capacity of the gateway) to obtain authorization data from an authorization database. The authorization data for the POS cash disbursement, including an indication of whether the POS cash disbursement request is declined or accepted, is returned to the EFT gateway and then the computer network. If approved, the cardholder is provided cash at the POS in the amount of the requested POS cash disbursement.

The cash disbursement methods and processes disclosed herein may be used alone or in combination with one or more of the purchase transactions, including but not limited to those disclosed herein.

In some embodiments, methods disclosed herein may be implemented using a combination of hardware and software, including program code instructions embodied on a variety of media, including, for example, a CD-ROM, programmable memory, nonvolatile memory, etc.

Although the present disclosure has been described with respect to example embodiments thereof, those skilled in the art will appreciate that various substitutions or modifications may be made without departing from the spirit and scope of the present disclosure.

1. A method, comprising:
receiving account information from a payment card device for a purchase transaction, wherein an unrestricted funds account is associated with the payment card device and a restricted funds account is associated with the payment card device;
receiving account type data representative of one of the unrestricted funds account and the restricted funds account to associate with the purchase transaction by a transaction terminal;
transmitting payment transaction data, including the account type data, from the transaction terminal to a payment network;
routing the payment transaction to one selection of a first network and a second network based on the account type data associated with the payment transaction data;
determining whether the routing is successful; and
re-routing, in an instance the routing is not successful, the payment transaction to the one of the first network and the second network not selected in the routing of the payment transaction.

2. The method of claim 1, wherein the restricted funds account is associated with at least one government benefit program.

3. The method of claim 1, wherein the restricted funds account is restricted to an association with only specific types of a purchase transaction and no restrictions apply to an association of the unrestricted funds account to a purchase transaction.

4. The method of claim 1, wherein the transaction terminal is adapted to receive account type data representative of both the unrestricted funds account and the restricted funds account for the purchase transaction.

5. The method of claim 1, further comprising:
receiving a restricted funds account code in the instance the account type data associated with the purchase transaction is representative of the restricted funds account; and
transmitting, with the payment transaction data, the restricted funds account code.

6. The method of claim 1, further comprising a cardholder authentication process, wherein cardholder authentication process includes receiving a personal identification number (PIN) in the instance the account data type is representative of the restricted funds account and the cardholder authentication process includes receiving at least one of a PIN and a signature in the instance the account data type is representative of the unrestricted funds account.

7. The method of claim 1, wherein the unrestricted funds account is associated with at least one of a credit card account, a debit card account, and a stored value card account.

8. The method of claim 7, wherein the credit card account is a private store credit card account.

9. The method of claim 1, wherein the payment card device is one of an automatic teller machine (ATM) and a point of sale (POS) terminal.

10-18. (canceled)

19. A storage medium having executable computer readable instructions stored thereon, the storage medium comprising:
instructions to receive account information from a payment card device for a purchase transaction, wherein an unrestricted funds account is associated with the payment card device and a restricted funds account is associated with the payment card device;
instructions to receive account type data representative of one of the unrestricted funds account and the restricted funds account to associate with the purchase transaction by a transaction terminal;
instructions to transmit payment transaction data, including the account type data, from the transaction terminal to a payment network;
instructions to route the payment transaction to one selection of a first network and a second network based on the account type data associated with the payment transaction data;
instructions to determine whether the routing is successful; and
instructions to re-route, in an instance the routing is not successful, the payment transaction to the one of the first network and the second network not selected in the routing of the payment transaction.

20. The storage medium of claim 19, wherein the restricted funds account is associated with at least one government benefit program.

21. The storage medium of claim 19, wherein the restricted funds account is restricted to an association with only specific types of a purchase transaction and no restrictions apply to an association of the unrestricted funds account to a purchase transaction.

22. The storage medium of claim 19, further comprising:
instructions to receive a restricted funds account code in the instance the account type data associated with the purchase transaction is representative of the restricted funds account; and
instructions to transmit, with the payment transaction data, the restricted funds account code.
